(19) United States
(12) Patent Application Publication
(10) Pub. No.: US 2011/0074135 A1
(43) Pub. Date: Mar. 31, 2011

(54) AIRBAG IDENTIFICATION SYSTEM

(75) Inventor: John D. Thomas, Rochester, MI (US)

(73) Assignee: ALTe, Bloomfield, MI (US)

(21) Appl. No.: 12/568,109

(22) Filed: Sep. 28, 2009

(51) Int. Cl. B60R 21/20

(52) U.S. Cl. 280/728.3

(57) ABSTRACT

A vehicle includes at least one power source and at least fuel source connected to the at least one power source for powering the vehicle. A safety system for the vehicle includes an airbag having an outer material visible when the airbag is in a deployed position. The outer material for the airbag is marked to correspond to the at least one fuel source.

### TECHNICAL FIELD

The present invention relates, generally, to a vehicle having a supplemental restraint system, and more specifically, to an airbag identification system within the supplemental restraint system.

### BACKGROUND OF THE INVENTION

Advancements in technology and the growing concern for environmentally efficient vehicles have led to the use of alternate fuel and power sources for vehicles. Different fuel and power sources each offer distinct advantages. However, in the event of a vehicular accident respondents must respond in different manners depending on the fuel and power sources for that particular vehicle. If the fuel and power source for that vehicle are not known then this may delay the respondents' ability to take action.

### SUMMARY OF THE INVENTION

An airbag identification system for a vehicle is provided. A vehicle includes at least one power source and at least fuel source connected to the at least one power source for powering the vehicle. A safety system for the vehicle includes an airbag having an outer material visible when the airbag is in a deployed position. The outer material for the airbag is marked to correspond to the at least one fuel source.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a vehicle having a supplement restraint system; and

FIG. 2 is a schematic illustration of the deployed airbag for the vehicle of FIG. 1.

### DESCRIPTION OF THE PREFERRED EMBODIMENTS

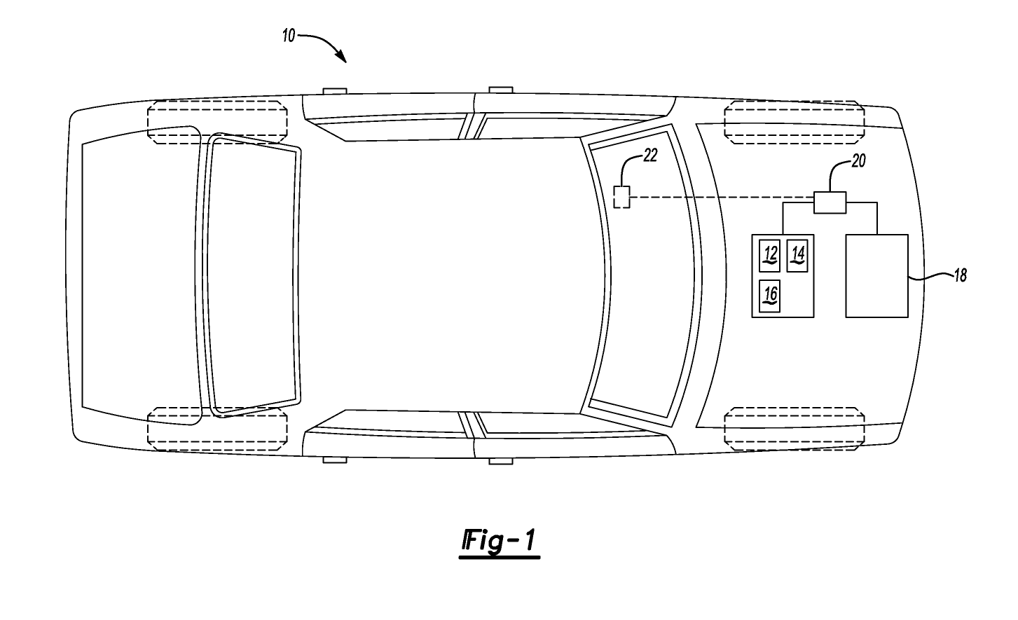

Referring to the Figures, wherein like reference numbers refer to the same or similar components throughout the several views, FIG. 1 schematically illustrates a vehicle 10 including at least one power source 12 and at least one fuel source 14. The power source 12 and the fuel source 14 may be any known combination. For example, the power source 12 may be a combustion engine and the fuel sources may be unleaded gasoline. Other known combinations may also be used, such as an electric motor and battery, or a fuel cell and the corresponding fuel type, such as hydrogen, etc.

A safety system 16 for the vehicle 10 includes a supplemental restraint system 18 which includes at least one airbag 20. The airbag 20 may be any airbag 20 that visibly deploys in the event of an accident. For example, the driver side forward airbag, the passenger side forward airbag, side impact airbags for the driver side or the passenger side of the vehicle. However, as described below, the safety system 16 is preferably applied to all airbags 20 within the vehicle 10.

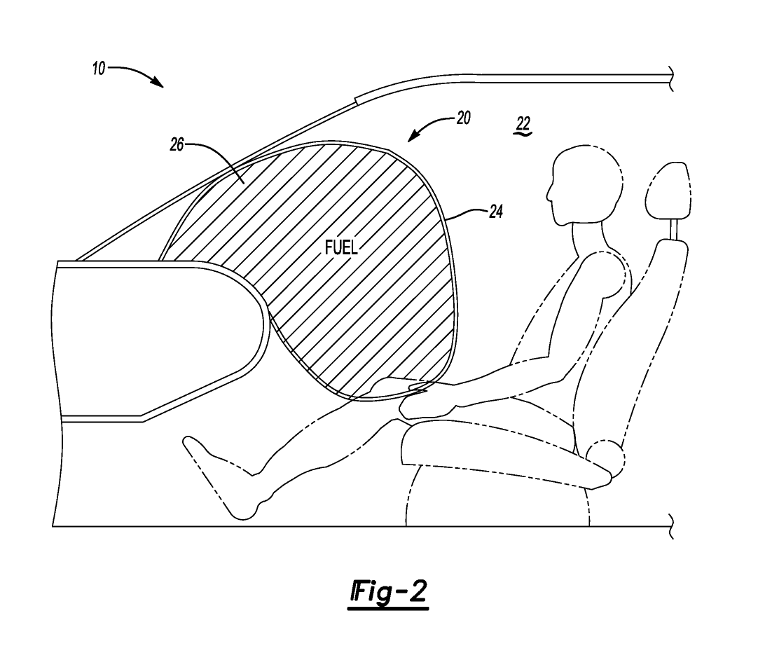

FIG. 2 illustrates a passenger compartment 22 for the vehicle 10. An airbag 20 for the safety system 16 is illustrated in the deployed position. The airbag 20 includes an outer airbag material 24. The airbag 20 may be a single layer of material. In this instance, the outer airbag material 24 would also form the airbag 20 itself The outer airbag material 24 is visible when the airbag 20 is in the deployed position. The outer airbag material 24 has a marking corresponding to the type of fuel source 14 (shown in FIG. 1) for the vehicle 10. Each type of fuel source 14 may be assigned a marking 26. The marking 26 may be a specific color, symbol, pattern, etc. For example, if the vehicle 10 utilizes biofuel as the fuel source 14 then the airbag 20 may be colored green and/or labeled with the word biofuel. As shown in FIG. 2, the marking 26 is shown as a cross-hatch, which may identify a particular fuel such as hydrogen, etc. Alternatively, the marking 26 may be used to identify the type of battery used. In this manner, respondents to situations where an airbag 20 has deployed may be informed as to the type of fuel source 14 for the vehicle 10 and may quickly employ the correct safety precautions for that type of material.

Vehicles may also have multiple power sources 12 and fuel sources 14 of different types. For example, a hybrid electric vehicle 10 has unleaded gasoline as a first fuel source 14 and an internal combustion engine as a first power source 12 and a battery as a second fuel source 14 and a motor as a second power source 12. In this manner, the airbag 20 may have the outer airbag material 24 with multiple colors or markings 26. For example, alternating stripes of blue and yellow representing the battery and the unleaded gasoline respectively. Additionally, different types of fuel cells and batteries may utilize different materials and each of these materials may be assigned different colors or markings 26.

Alternatively, different fuel sources 14 which require the same safety precautions may be assigned similar colors/markings 26. For example, unleaded fuel and diesel fuel both require the same type of safety precautions, such as fire suppressants, therefore unleaded fuel and diesel may be assigned the same color/marking 26.

In this manner, a safety system 20 for quickly informing people of a fuel source may be employed. A standardized color/marking system assigned for fuel sources may be disseminated to the public and in particular to safety respondents.

While the best modes for carrying out the invention have been described in detail, those familiar with the art to which this invention relates will recognize various alternative designs and embodiments for practicing the invention within the scope of the appended claims.

1. A vehicle comprising:
at least one power source;
at least fuel source connected to the at least one power source for powering the vehicle;
an airbag for the vehicle;
an outer material for the airbag visible when the airbag is in a deployed position; and
wherein the outer material for the airbag is marked to identify the at least one fuel source.

2. The vehicle of claim 1, wherein the outer material is marked with a color that corresponds to the type of fuel source.

3. The vehicle of claim 1, wherein the outer material is marked with a word that corresponds to the type of fuel source.

4. The vehicle of claim 1, wherein the outer material is marked with a color and a word that both correspond to the type of fuel source.

5. The vehicle of claim 1, wherein the vehicle has a plurality of fuel sources and wherein the outer material has a plurality of markings each corresponding to a respective one of the plurality of fuel sources.

6. The vehicle of claim 1, wherein the airbag is a single layer of material.

7. The vehicle of claim 1, wherein the at least one fuel source is a battery and the outer material is marked with a marking that corresponds to the type of battery used.

8. A safety system for a vehicle comprising:
an airbag;
an outer material for the airbag visible when the airbag is in a deployed position; and
wherein the outer material for the airbag is marked to correspond to at least one fuel source for the vehicle.

9. The safety system of claim 8, wherein the outer material is marked with a color.

10. The safety system of claim 8, wherein the outer material is marked with a word.

11. The safety system of claim 8, wherein the outer material is marked with both a color and a word.

12. The safety system of claim 8, wherein outer material has a plurality of markings each corresponding to a respective one of a plurality of fuel sources.

13. The safety system of claim 8, wherein the airbag is a single layer of material.
